(19) United States
(12) Patent Application Publication
(10) Pub. No.: US 2010/0325206 A1
(43) Pub. Date: Dec. 23, 2010

(54) PROVIDING COLLABORATIVE BUSINESS INTELLIGENCE

(76) Inventors: UMESHWAR DAYAL, Saratoga, CA (US); Ravigopal Vennelakanti, Bangalore (IN); Ratnesh Kumar Sharma, Fremont, CA (US); Maria G. Gastellanos, Sunnyvale, CA (US); Ming C. Hao, Palo Alto, CA (US); Chandrakant Patel, Fremont, CA (US); Sangamesh S. Bellad, Bangalore (IN); Manish Gupta, Sunnyvale, CA (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/486,816

(22) Filed: Jun. 18, 2009

(51) Int. Cl. G06F 15/16

(52) U.S. Cl. 709/204

(57) ABSTRACT

To provide collaborative business intelligence in an enterprise, an analytics platform is provided to receive an event associated with the enterprise and to perform analysis in response to the event. A virtual collaboration platform is provided to enable plural users to interact with each other and to use resources of the analytics platform.

### BACKGROUND

As enterprises (e.g., companies, educational organizations, government agencies, and so forth) become more automated and as such enterprises increasingly engage in real-time and data-driven operations, business intelligence (BI) has increasingly been incorporated into enterprise operations. The term “business intelligence” refers to one or more of the following: data warehousing, data mining, analytics, reporting, visualization, and other processes. Business intelligence is typically performed by an enterprise in an offline manner, and usually by a relatively small number of expert users in the enterprise who are able to analyze historical data to prepare reports or build models, which are used to perform decision making.

As a result, conventional business intelligence techniques are generally not flexible and are of relatively limited use to most users within an enterprise. Moreover, decision making based on use of conventional business intelligence techniques tend to focus on just information from specific domains, which may not be optimal. Also, conventional BI techniques tend to be performed in an offline manner.

### BRIEF DESCRIPTION OF THE DRAWINGS

Some embodiments of the invention are described with respect to the following figures:

FIG. 1 is a schematic diagram of various layers of a collaborative business intelligence mechanism according to an embodiment;

FIG. 2 illustrates a virtual room in which users can collaborate according to an embodiment;

FIG. 3 is a block diagram of an exemplary arrangement in which a business intelligence mechanism can be provided, in accordance with an embodiment;

FIG. 4 is a flow diagram of a business intelligence process according to an embodiment;

FIG. 5 is a schematic diagram that illustrates a “glue” layer for the collaborative business intelligence mechanism, according to an embodiment; and

FIGS. 6-8 illustrate various use cases of the collaborative business intelligence mechanism according to an embodiment.

### DETAILED DESCRIPTION

In general, according to some embodiments, a collaborative business intelligence mechanism is provided that includes a query and analytics (business intelligence) platform that is integrated with (or embedded in) a virtual collaboration platform. The term “platform” refers to a collection of one or more modules to perform predefined tasks. The collection of modules of a platform can reside in one physical system, or can be distributed across multiple physical systems in one or more geographic regions.

The query and analytics platform is able to receive a query to perform a requested action associated with an enterprise (e.g., company, educational organization, government agency, etc.) and to perform analysis in response to the query. The query and analytics platform includes various modules to perform respective processing tasks, which are described further below. Alternatively, instead of performing analysis in response to queries, the analysis can be performed in response to other events. The query and analytics platform includes resources that can be provided to aid users in the analysis, where such resources can include models, software applications, data sources, and others.

The virtual collaboration platform enables multiple users to interact with each other and to use the query and analytics platform. Collaborative business intelligence (BI) sessions may be established in response to various events, such as events that may involve users from multiple domains to cooperate to troubleshoot a problem or to cooperate to understand the status of an issue in the enterprise. In some embodiments, the virtual collaboration platform presents a virtual environment (e.g., a virtual room, a virtual meeting place, etc.) in which the multiple users are able to interact with each other (e.g., text chat, voice chat, video conferencing, sketching, gesturing, etc.) to share information, to view information of interest, to analyze information, to exchange ideas, to execute application programs, and/or to perform other tasks. A collaborative BI session refers to a session in which a virtual environment is established to enable interaction among multiple users, where resources and analysis provided by the query and analytics platform can be leveraged. A collaborative BI session presents a rich interface to provide effective communication and collaboration over a large volume of data. In this way, the collaborative business intelligence mechanism enables collaborative decision making among multiple users from different domains of an enterprise, or even from multiple enterprises.

The collaborative business intelligence mechanism according to some embodiments is able to address issues associated with conventional business intelligence techniques that do not allow information from different domains of an enterprise to be considered for analysis and/or decision making. Such conventional business intelligence techniques may provide solutions or results that do not consider multiple pieces of relevant information, such that any such solutions or results may be incomplete. Also, conventional business intelligence techniques tend to be performed in an offline manner, whereas most business operations would benefit more from collective online and interactive decision making by groups of people.

A virtual environment provided by the virtual collaboration platform can be, for example, a three-dimensional (3D) virtual room in which representations of relevant aspects of an enterprise are displayed to allow the multiple users to more easily make decisions regarding a course of action to take. By presenting virtual environments where users can meet to collaborate, users do not have to travel from remote locations to meet in the same physical location, which avoids travel costs and enhances time efficiency.

In one example, aspects of a data center infrastructure of the enterprise may be monitored, where the data center infrastructure can include computer systems (e.g., servers, storage subsystems, communications equipment, and so forth), cooling subsystems, and power systems. Various events associated with the data center infrastructure may be observed by monitoring devices, such as monitoring devices to detect temperature information, power information, fault information, and so forth. In response to such events, a data center facilities manager may wish to consult with an information technology systems manager, a power management and distribution team, a chiller management team, and/or design engineers of the data center to better understand the events.

The virtual room presented by the virtual collaboration platform allows the data center facilities manager to meet with users from the other domains such that the data center facilities manager can exchange information with such other users. Also, the virtual room can provide interactive visualizations of the various aspects of the data center that may be of interest and that may be important to users of the other domains in better understanding the events that have been detected. Interactive visualization refers to providing a graphical output (e.g., report, chart, etc.) to a user, where the user is able to interactive make selections in the graphical output to request further data or to request that an action be taken. Moreover, queries can be submitted from the virtual room by the various users that are meeting in the virtual room to request pertinent information or to perform desired analyses.

The collaborative business intelligence mechanism according to some embodiments is an online system that is able to consider both real-time data and historical data from various different data sources. The ability to consider real-time data allows faster decision making in response to events. “Real-time” consideration or analysis of data refers to considering or analyzing such data as data is continually received by a system (as opposed to an offline mode of operation where the consideration or analysis is performed on previously stored data only). In addition, the ability to consider historical data allows users of the collaborative business intelligence mechanism to view historical operational data of the enterprise such that current events can be better understood.

Some example components of the query and analytics platform include a query and visual analytics engine to submit queries and to generate reports (such as visualization screens that contain representations of historical and real-time data associated with the enterprise); a metrics computation engine to compute at least one metric regarding a characteristic of the enterprise; a correlation engine to detect time-dependent relationships among operational data of the enterprise; a prediction engine to predict a future condition of an aspect of the enterprise; a knowledge model mapping module to map events to experts; and other components.

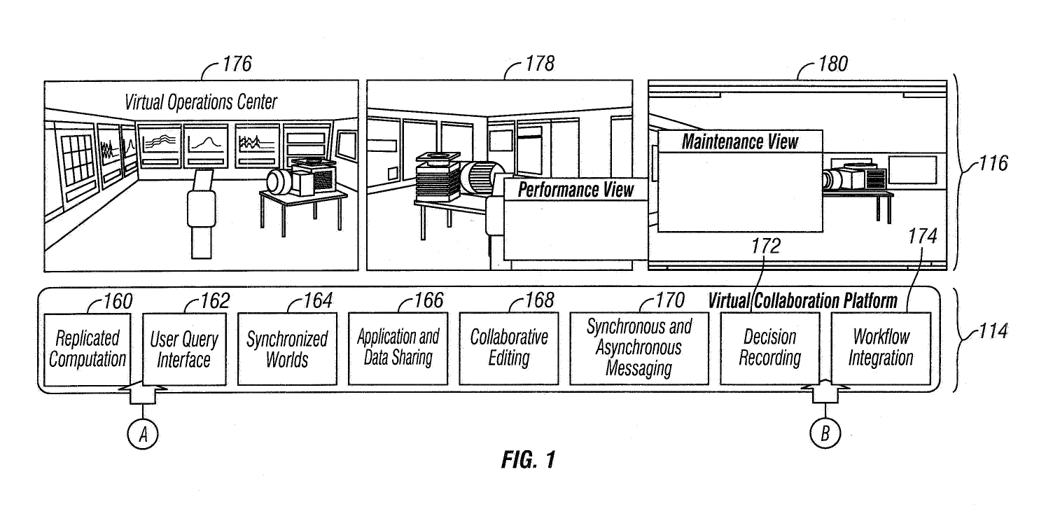

FIG. 1 is a schematic diagram of a collaborative business intelligence mechanism, which includes various layers. As shown in FIG. 1, a first layer includes a data source layer 102 that includes various types of data sources, including databases 120, 3D models 122 (e.g., 3D models of enterprise equipment and systems), unstructured data 124 (e.g., text, audio data, video data, multimedia data relating to various aspects of the enterprise, such as schedules, warranty information, etc.), software applications 126 (e.g., applications that monitor a business process or asset and data associated with its operation), sensor data 128 (collected by one or more sensors associated with equipment and systems in an enterprise), knowledge management and expert tracking systems 130 (information relating to various subject matter experts that allow such experts to be identified if their assistance would be useful for collaborative business intelligence), analytical models 132 (e.g., models to correlate events or patterns in the enterprise), industry benchmarks 134 (e.g., guidelines regarding operations and performance to help users when collaborating), and process models 136 (models of various processes within the enterprise).

The various data sources of the data source layer 102 are coupled to data channel adapters 104. The data sources 120-136 shown in FIG. 1 can be located in different computers (either within the enterprise or outside the enterprise). Such computers can be connected by one or more networks to the data channel adapters 104, which provide connectivity and access to the data sources. The data channel adapters 104 map the various data sources of the data source layer 102 to handlers that enable query, function calls, and updates of the underlying data sources.

Another layer above the data channel adapters 104 is a business intelligence integration layer 106, which supports the federation of the underlying data sources. The business intelligence integration layer 106 models and maps the low-levels semantics and syntax for interfacing with the specific handlers of the data channel adapters 104. The business intelligence integration layer 106 provides functionality to extract, integrate, clean, and transform data from the various data sources of the data source layer 102 into formats that are suitable for business intelligence. Conversely, the business intelligence integration layer 106 is also able to decompose, map, and translate business intelligence queries into queries or function calls compatible with the various data sources of the data source layer 102. In sum, the business intelligence integration layer 106 can be considered a translation and mapping layer to translate between semantics and syntax of the collaborative business intelligence mechanism and the data sources of the data source layer 102.

The business intelligence integration layer 106 can also include one or more caches 138 to store selected data from the data sources of the data source layer 102. The decision as to whether or not to cache data in the caches 138 of the business intelligence integration layer 106 can depend on various factors, such as response time latencies, frequency of update of the data, performance of the underlying data sources, extent of data cleaning involved, and data ownership considerations. Caching data in the caches 138 allows for faster performance in response to queries of the collaborative business intelligence mechanism.

Another layer above the business intelligence integration layer 106 is the ontology and metadata layer 108. The ontology and metadata layer 108 models the semantics of business processes, domain knowledge, and data or information models, and their interdependencies and associations. The models of the ontology and metadata layer 108 can include information models, task and process models, and user and knowledge models. The ontology and metadata layer 108 presents a view of how data elements in each of the specific data sources relate to their information in knowledge models integrated into the collaborative business intelligence mechanism. These relationships are modeled from the perspective of the business processes and end users.

The ontology and metadata layer 108 defines the relationships between data elements from different data sources, the relationships between events and process steps, and the relationships between issues and experts. For example, in the data center context, the ontology and metadata layer 108 maps the associations between thermal performance indicators, information technology systems workload, power consumption specifications, the knowledge experts who understand each of the domains, the facilities operations management specifications, industry benchmark guidelines, maintenance information about specific objects and other information about the data center, and so forth. Examples of associations are shown in FIG. 1 in the ontology and metadata layer 108. Also, in one example, the metadata represented in the ontology and metadata layer can be used to resolve the following query: “Identify all currently available knowledge experts who are associated with troubleshooting a sudden spike in thermal performance indicators.”

In addition, a business intelligence query and analytics layer 110 is provided above the ontology and metadata layer 108. The business intelligence query and analytics layer 110 provides tools, software applications, and functions (collectively referred to as “modules”) that provide the core business intelligence capabilities of the collaborative business intelligence mechanism. Together the business intelligence query and analytics layer 110, ontology and metadata layer 108, business intelligence integration layer 106, and data channel adapter layer 104, are collectively referred to as an operational business intelligence platform 112 (which is referred to above as the “query and analytics platform”).

Example modules in the business intelligence query and analytics layer 110 are shown in FIG. 1. Such modules include a query and visual analytics engine 140, which is able to receive queries from users and to provide reports in response to such queries. The query and visual analytics engine 140 can include visual analytic tools, which allow a user to interactively explore data sets (such as data sets contained in various data sources of the data source layer 102). The visual analytic tools can produce a visualization of one or more attributes of data sets, as well as aggregations or other analyses performed on such attributes. The attributes of the data sets can be organized in a predefined manner such that a user can easily understand the content of the data sets. For example, the visualization can allow a user to more quickly determine correlations among different attributes of the data set, such that any anomalies can be more easily detected.

The visualizations provided can be real-time views of the enterprise's assets, processes, performance and risk indicators, and other related information.

Another module in the business intelligence query and analytics layer 110 is a metrics computation engine 142, which performs evaluation of domain-specific, process-specific, and/or user-specific metrics that describe characteristics of aspects of the enterprise, such as the performance of a component in the enterprise, or any other characteristic. For example, metrics can be defined to measure characteristics of process instances, resources, or an overall business operation. Analysts may want to define and analyze key business performance indicators such as compliance with service level agreements; the quality of a process instance, where quality can be characterized as excellent, good, fair, or poor; performance measures such as process duration or throughput; and/or assessments of resource performance, such as utilization or uptime.

Another module in the business intelligence query and analytics layer 110 is a time-correlation engine 144 that is used for automatic detection of time-dependent relationships among business metrics and/or operational data (data obtained during execution of one or more aspects of the enterprise). Detection of time-dependent relationships among hundreds or thousands of numeric variables is a relatively difficult task that has to be performed to understand the cause-effect relationship among various events in an enterprise. An input to the time-correlation engine 144 can be a set of numeric data streams, each of which contains recorded numeric values of a corresponding variable (business metric or operational data variable) over time. The output of the time-correlation engine 144 is a set of time-correlation rules that explain time-dependent relationships among data streams (and numeric variables). Numeric data streams are transformed into sequences of discrete events that correspond to change points (or landmarks) in numeric values that are used to summarize the behavior of numeric variables.

The time-correlation engine 144 is able to compare change events from different data streams to detect co-occurrences of such events and to calculate the statistical significance of the co-occurrences of the events. The time-correlation engine 144 can also calculate the typical time difference of the repeating co-occurrence patterns across data streams to generate time-correlation rules. Each time-correlation rule contains one or more of the following information: numeric variables (data streams) that have time-dependent relationships; type of time-correlation (same or opposite direction); sensitivity of time-correlation (how much the changes in one set of variables affect the variables of another set of variables); and/or confidence of the generated rule. One example of a typical time-correlation rule can be as follows: A increases more than 5%→B decreases more than 10% within two hours (confidence 85%). The time-correlation engine 144 can also perform time-delay correlation.

Another module in the business intelligence query and analytics layer 110 is a prediction engine 146 that is able to make a prediction regarding a future value of a metric such that users can proactively optimize business or operational processes, such as to improve their performance relative to define metrics. Predictions can be done at the instance level or at the aggregate level. In an order processing example (in which orders are received for services or goods), an enterprise may want a prediction of the duration metric for specific order of a customer to see if the enterprise can deliver the goods on time—if not, then the priority of the order can be increased so that the order can be satisfied on time. This is an example of an instance-based prediction (the prediction is performed for a given instance of an enterprise operation while the instance is being executed).

In contrast, the enterprise may also wish to know if the average duration of orders on a certain day of next week (or some other future time period) will exceed a promised 24-hour delivery time (which can be a potential violation of a service level agreement). If so, then the enterprise may wish to plan for extra resources. This type of prediction is an aggregate-level prediction that is a class-based, time-series prediction, since it applies to a class of operations of the enterprise.

Instance-based prediction uses instance properties (e.g., day of the week that an order was submitted, type of product, region, etc.) to learn a prediction model (such as a decision tree or other type of prediction model). For example, a pattern may indicate that if an order was received on a Friday afternoon, there is an 85% chance that the order will not be shipped in less than 24 hours. A challenge for instance-based predictions is that as a process instance makes progress in its execution, the predictions for the process instance should be updated with additional execution data associated with the process instance as the execution data becomes available. This means that different prediction models are built for relevant execution stages of a process.

A class-based, time series prediction is a relaxed form of time series forecasting, which takes advantage of the fact that extreme accuracy does not have to be provided when the goal is to predict whether a given metric will fall between specified tolerance bounds. The challenge is to automate the forecasting process to enable the analysis of hundreds or even thousands of business process metric time series. The main idea is to characterize a time series according to its components (e.g., trend and seasonality) and then apply the most appropriate technique(s) to create the relatively good forecasting model. Once the model is created, the model can be applied to obtain a numeric prediction which is matched to the corresponding class. It is desirable to know when a model is no longer accurate such that the model can be updated incrementally.

The prediction engine 146 allows personnel of the enterprise to proactively anticipate situations and perhaps prevent problems from occurring by initiating changes in the enterprise, such as by changing system design, changing an operational process, or changing a control setting.

Another module of the business intelligence query and analytic layer 110 is a trending analysis engine 148, which is used to identify trends in one or more metrics of interest.

Yet another module of the business intelligence query and analytics layer 110 is a knowledge model mapping module 150, which is used to map the events or issues of the enterprise to respective experts that are best suited to handle or collaborate regarding such events or issues. For example, upon detecting that there is a temperature increase in a data center and an increase in workload, the knowledge model mapping module 150 can be consulted to identify the knowledge (subject matter) experts that have expertise in dealing with problems associated with elevated data center temperature and elevated data center workload area.

Generally, the operational business intelligence platform 112 provides the business intelligence, data aggregation, and knowledge expert mapping capabilities of the collaborative business intelligence mechanism. As further shown in FIG. 1, the various components of the operational business intelligence platform 112 are integrated with the virtual collaboration platform 114 to enable remote users to be able to view, share, analyze, and collaborate using information modeled in several forms. The virtual collaboration platform 114 also provides mechanisms to capture user decisions recorded in the virtual environment, and re-associates the captured user positions with specific events, models, and business processes.

FIG. 1 shows three views 176, 178, and 180 of virtual environments that can be presented to collaborating users in a collaborative BI session. The views 176, 178, and 180 can be presented locally on display devices connected to client computers of the users.

The virtual collaboration platform 114 includes a replicated computation module 160 to provide an architecture based on a replicated computational model to synchronize the virtual worlds (synchronized virtual worlds 164 shown in FIG. 1) of each of the participants in the virtual environment. This architecture allows users to collaborate in a highly flexible manner. Participants can view information relevant to them, yet be synchronized with other participants' views. Transformations performed on the objects, software applications, data models, 2D or 3D models are instantaneously replicated across client computers of all participants. This ensures that geographically distributed knowledge experts can view information, correlate events and collaborate in this environment to take effective business or operational decisions. This model ensures deterministic outcomes for the replicated computational transformations, and enables leveraging of the client computers' computation capabilities to render the transformations occurring in the virtual worlds independent of the geographic location from where the changes originated.

The virtual collaboration platform 114 further includes a user query interface 162 that can be accessed in the different views of the collaborating users to issue queries to the operational business intelligence platform 112.

The virtual collaboration platform 114 also allows software application and data sharing 166 (to allow the collaborating users to share data as well as software applications), collaborative editing 168 (to allow collaborating users to edit a common document or other object), synchronous and asynchronous messaging 170 (to allow messages to be exchanged between collaborating users, such as be e-mail, text chat, voice chat, etc.), and decision recording 172 (to record decisions made in a collaborative session). The virtual collaboration platform 114 also provides workflow integration 174 to integrate different workflows associated with different domains.

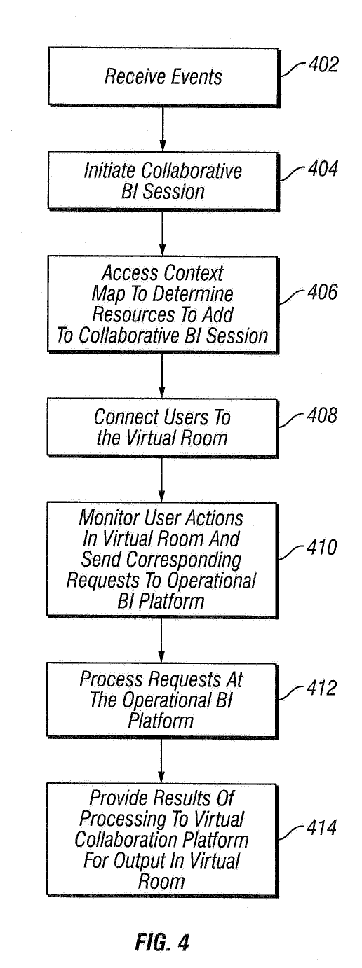

As further shown in FIG. 5, a “glue” layer is also provided to link the operational BI platform 112, virtual collaboration platform 114, as well as a layer 502 that includes applications and application workflows. The applications and application workflows 502 represent various processes that may be invoked in response to events. For example, an application or application workflow may refer to a process to be performed when some event is detected, such as excessive system loading or temperature in a data center, a fault condition, or any other event).

The glue layer in FIG. 5 is represented by block 500, which includes context maps and resource semantics. A context map provides a mapping of a context (e.g., an excessive system loading situation, a high temperature situation, a situation involving a hardware or software fault, etc.) to resources that are to be added to a collaborative BI session to allow for troubleshooting or other tasks. For example, the context map may specify what data sources are to be accessed, models to use, software applications to invoke, experts to consult, and so forth.

The resource semantics define how various components are related, including the data sources and various elements of the ontology and metadata layer 108.

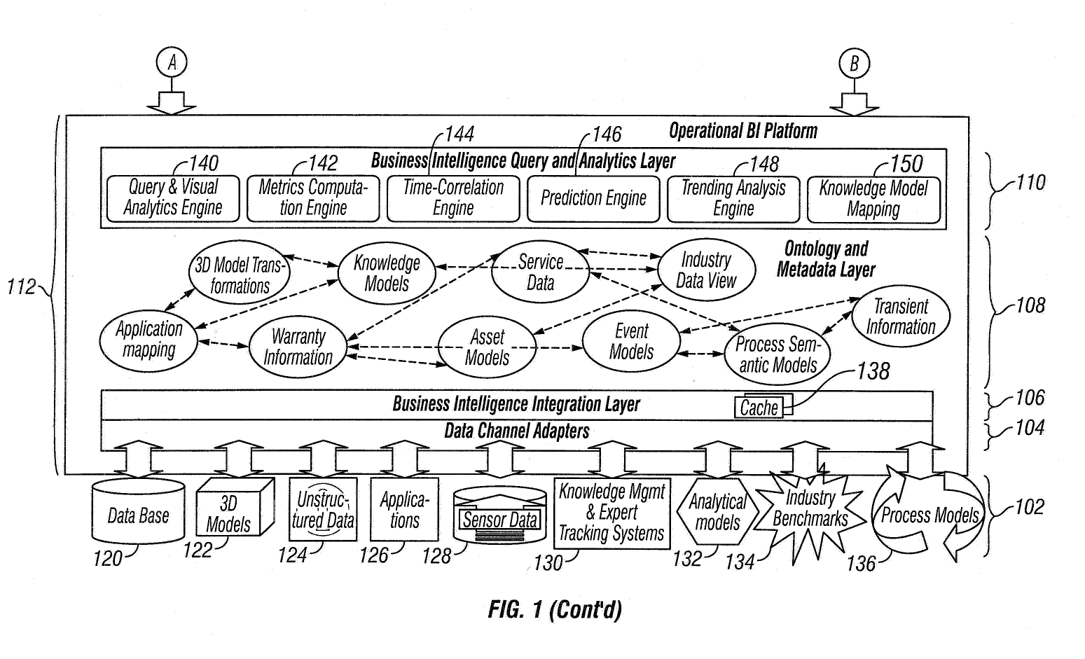

FIG. 2 shows an exemplary enlarged view 200 that represents a virtual room in which two collaborating users are virtually located. In the virtual room shown in the view 200, various visualization screens 202, 204, and 206 are displayed to show various attributes and results. Also, a representation 208 of the equipment being studied can also be provided in the virtual room. For example, the virtual room represented in FIG. 2 can be a data center room that contains data center equipment, such as the equipment represented by the representation 208.

An example use case is described below. Note that the use case is provided for purposes of illustrating an example use of the collaborative business intelligence mechanism according to some embodiments. Other implementations will have other use cases.

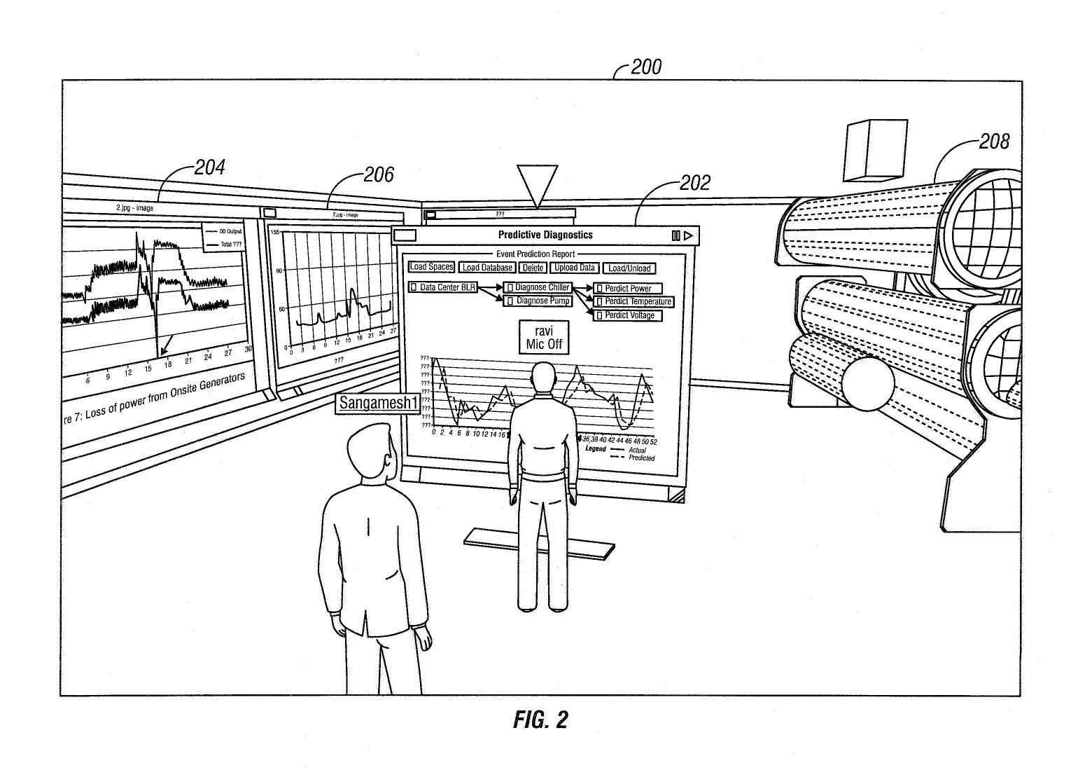

FIG. 3 shows an exemplary arrangement that includes client computers 302A and 302B that are coupled to a BI (business intelligence) computer system 300. The BI computer system 300 can be implemented with one server computer or with multiple server computers. If implemented with multiple server computers, the multiple server computers can be distributed across different geographic locations.

The client computers 302A and 302B can be associated with respective users. For example, one user can be a data center facilities manager, while another user can be an information technology manager.

The client computers 302A and 302B include respective display devices 304A, 304B. Each of the display devices 304A, 304B displays a respective view 306A, 306B of a virtual room 308 that is generated by the virtual collaboration platform 114 in the BI computer system 300 for a particular collaborative session. The views 306A, 306B can be generated by the replicated computation module 160 (FIG. 1) in the virtual collaboration platform 114 that provides synchronized worlds 164 (as explained above).

Data between the client computers 302A, 302B and the virtual room 308 can be exchanged over network paths 320, 322 (which can be part of a network 316 or another network). Within the virtual room 308, the users at client computers A, B can access information for viewing, edit information, exchange information, submit queries to the operational business intelligence platform 112, and/or perform other tasks.

Based on activities in the virtual room 308 by one or more collaborating users at with the client computers 302A, 302B, the virtual collaboration platform 114 can send requests (at 324) to the operational business intelligence platform 112. The operational business intelligence platform 112 responds to the requests by sending responses (at 326) back to the virtual collaboration platform 114.

The components of the virtual collaboration platform 114 and operational BI platform 112 can be software components that are executable on one or multiple central processing units (CPUs) 310 in the BI computer system 300. The CPU(s) 310 is (are) connected to a storage 314 and a network interface 312.

The network interface 312 is connected to a network 316 to allow the BI computer 300 to obtain data from various data sources 318 and to communicate with the client computers 302A, 302B. The data sources 318 in FIG. 3 are part of the data source layer 102 shown in FIG. 1.

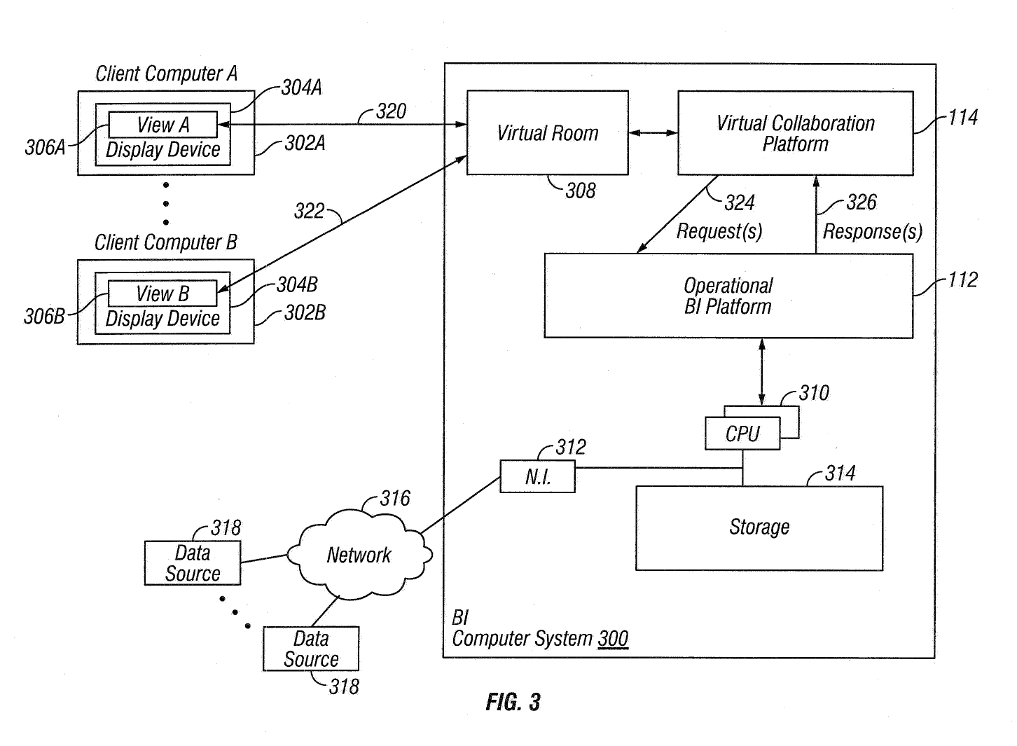

FIG. 4 is a flow diagram of a general process performed by an embodiment of the invention. Events are received (at 402) by the BI computer system 300. Events can include queries submitted by users. For example, users may desire to monitor various aspects of the enterprise, such as performance of equipment in a data center. The queries can be submitted to allow the users to receive interactive visualizations or other information from the BI computer system 300 regarding the aspects that are being monitored. Alternatively, events can refer to various situations that may be detected, such as an unplanned situation that may cause downtime, events detected based on monitoring system operation, initiation of workflows, and others.

In response to a detected event, a collaborative BI session is initiated (at 404). Initiating a collaborative BI session refers to either invoking a previously established collaborative BI session, or to starting a new collaborative BI session (where starting a new collaborative BI session is also referred to as provisioning the collaborative BI session). A context map (in block 500 shown in FIG. 5) is then accessed (at 406) to determine resources that are to be added to the collaborative BI session.

At some later point, one or more of users may decide to participate in the provisioned collaborative BI session to allow multiple users to interactively collaborate to address an identified event or issue. To allow users to participate in the collaborative BI session, a virtual room such as the virtual room 308 of FIG. 3 can be established. The users (and more specifically, the client computers associated with the users) are connected (at 408) to the virtual room 308. User actions in the virtual room are monitored (at 410), and these user actions are mapped to requests that can be sent from the virtual collaboration platform 114 to the operational business intelligence platform 112 (FIG. 3). The operational business intelligence platform then processes (at 412) these requests, and results of the processing are provided (at 414) to the virtual collaboration platform 114 for output (e.g., visualization graphs, reports, collaboration results, etc.) in the virtual room 308 (and ultimately for output in the respective views 306A, 306B (FIG. 3) presented to the respective collaborating users.

Note that as explained above, knowledge model mapping (150 in FIG. 1) is provided to allow identification of experts who can assist with specific issues. Such identified experts can be invited to participate in the collaborative session in the virtual room 308.

Also, processing of the requests received in the collaborative session involves integrating data from various different data sources, and using various models, including information models, task and process models, and user and knowledge models. The operational business intelligence platform 112 can perform analytics, such as data correlation, prediction, trending, and so forth, and provide the results of such analytics to the users. In addition, the BI computer system 300 can perform its tasks in real-time since it has access to real-time data.

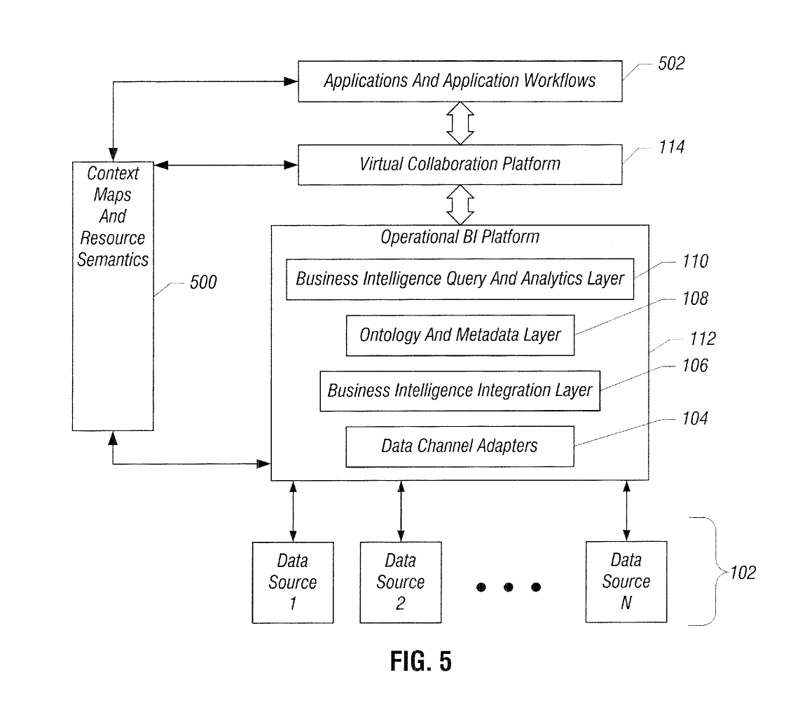

The following describes some exemplary use cases for collaborative business intelligence. FIG. 6 provides an example of provisioning a new collaborative BI session upon detecting (602) a situation in an enterprise. The detected situation may have caused downtime or some other unplanned situation. In response to detecting such a situation, a new virtual collaborative BI session is provisioned (at 604), and a plan is created to perform analysis of the detected situation. Also, in parallel with provisioning the collaborative BI session, knowledge experts are identified (at 606) for the detected situation.

After provisioning (at 604) the new collaborative BI session, one or more context maps are accessed (at 608) to load resources (e.g., models, software applications, data sources, etc.) into the provisioned collaborative BI session. Also, the knowledge experts identified (at 606) are invited (at 610) to participate in the collaborative BI session.

The BI system can also load (at 612) additional resources to run diagnostics with respect to the detected situation. Diagnostics and simulations are run (at 614). As part of running the diagnostics and simulations, a request can be submitted (at 616) for additional resources. The additional resources can then be loaded (at 618) into the collaborative BI session.

The experts are invited (at 620) to troubleshoot the detected situation. The experts can initiate (at 622) workflow(s) for resolving problems associated with the detected situation. The workflow(s) is (are) then integrated (at 624) to resolve the detected situation. Also, any actions taken in the collaborative BI session are recorded.

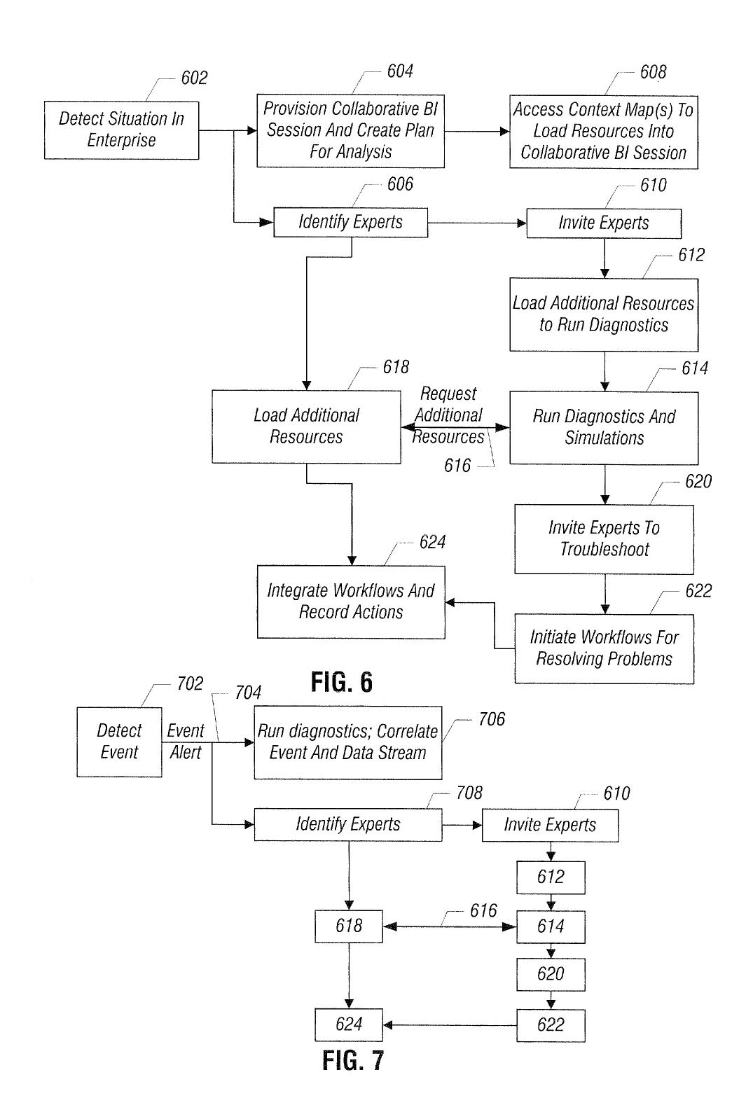

FIG. 7 illustrates another use case, in which real-time monitoring is performed of events (such as events in a data center). Note that as part of this real-time monitoring, a collaborative BI session has already been provisioned. Upon detecting (at 702) an event (e.g., over-temperature condition, excessive system loading, fault, etc.), an alert is provided (at 704), which causes diagnostics to be run (at 706) in the collaborative BI session to correlate the detected event to a particular data stream (e.g., stream of sensor data). Also, knowledge experts for the detected event are identified (at 708). The remaining tasks 610, 612, 614, 616, 618, 620, 622, and 624 are similar to those discussed above in connection with FIG. 6.

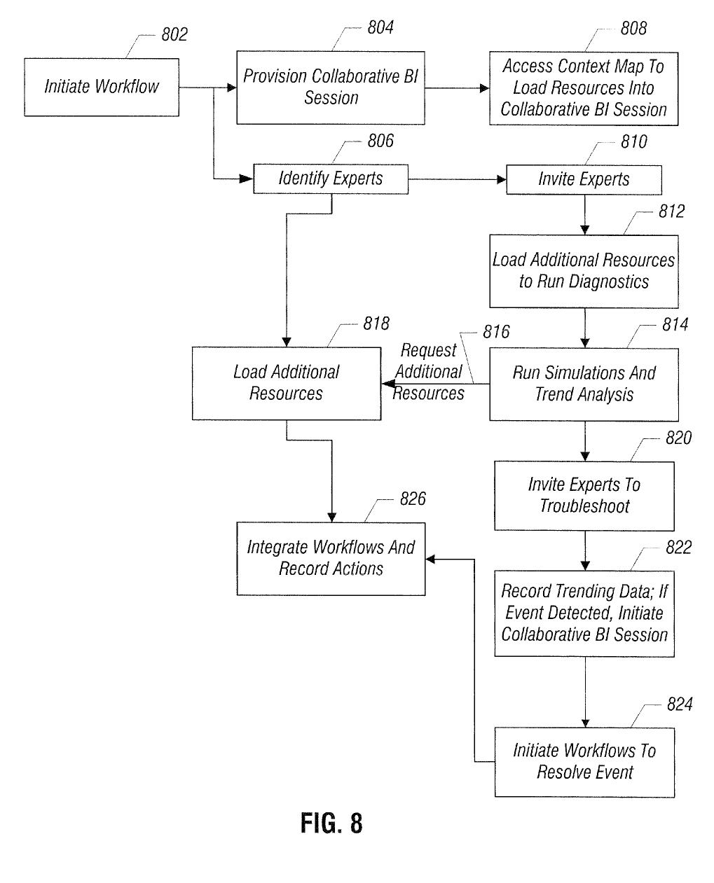

FIG. 8 illustrates yet another use case, which relates to initiating (at 802) a workflow to perform operations management in a data center. In response to detecting initiation of the workflow, a new virtual collaborative BI session is provisioned (at 804). Also, in parallel with provisioning the collaborative BI session, knowledge experts are identified (at 806) for the workflow.

After provisioning (at 804) the new collaborative BI session, one or more context maps are accessed (at 808) to load resources (e.g., models, software applications, data sources, etc.) into the provisioned collaborative BI session. Also, the knowledge experts identified (at 806) are invited (at 810) to participate in the collaborative BI session.

The BI system can also load (at 812) additional resources to run simulations with respect to initiated workflow. Simulations and trend analysis are run (at 814). As part of running the simulations and trend analysis, a request can be submitted (at 816) for additional resources. The additional resources can then be loaded (at 818) into the collaborative BI session.

The experts are invited (at 820) to troubleshoot the detected situation. The trend analysis can be performed on performance indicators, such as key performance indicators (KPIs) or key risk indicators (KRIs). The KPI and KRI trending data can be recorded (at 822). If the trending data indicates occurrence of an event that should be addressed, then a collaborative BI session is initiated. In performing diagnosis (at 824) of the detected event, other workflows can be initiated to resolve the event, and such workflows can be integrated (at 826) and any actions taken are recorded.

Instructions of software described above (including components of the operational business intelligence platform 112 and virtual collaboration platform 114 of FIG. 3) are loaded for execution on a processor (such as one or more CPUs 310 in FIG. 3). The processor includes microprocessors, microcontrollers, processor modules or subsystems (including one or more microprocessors or microcontrollers), or other control or computing devices. As used here, a “process” can refer to a single component or to plural components (e.g., one CPU or multiple CPUs).

Data and instructions (of the software) are stored in respective storage devices, which are implemented as one or more computer-readable or computer-usable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact disks (CDs) or digital video disks (DVDs). Note that the instructions of the software discussed above can be provided on one computer-readable or computer-usable storage medium, or alternatively, can be provided on multiple computer-readable or computer-usable storage media distributed in a large system having possibly plural nodes. Such computer-readable or computer-usable storage medium or media is (are) considered to be part of an article (or article of manufacture). An article or article of manufacture can refer to any manufactured single component or multiple components.

In the foregoing description, numerous details are set forth to provide an understanding of the present invention. However, it will be understood by those skilled in the art that the present invention may be practiced without these details. While the invention has been disclosed with respect to a limited number of embodiments, those skilled in the art will appreciate numerous modifications and variations therefrom. It is intended that the appended claims cover such modifications and variations as fall within the true spirit and scope of the invention.

What is claimed is:

1. A method of providing collaborative business intelligence in an enterprise, comprising:
providing, by a system including at least one computer, an analytics platform to receive an event associated with the enterprise and to perform analysis in response to the event; and
providing, by the system, a virtual collaboration platform to enable plural users to interact with each other in performing the analysis and to use resources of the analytics platform.

2. The method of claim 1, further comprising, in response to detecting an event, initiating a collaborative business intelligence session that employs the analytics platform and the virtual collaboration platform.

3. The method of claim 2, further comprising accessing at least one context map to identify, based on the detected event, the resources of the analytics platform to load into the collaborative business intelligence session.

4. The method of claim 2, wherein detecting the event comprises one or more of detecting an unplanned situation, detecting the event as part of real-time monitoring, and detecting initiation of a workflow.

5. The method of claim 2, further comprising inviting one or more experts to participate in the collaborative business intelligence session, wherein the one or more experts are identified based on information maintained by the analytics platform.

6. The method of claim 1, further comprising generating, by the virtual collaboration platform, a virtual environment in which the plural users are able to collaborate, wherein the virtual environment enables one or more of the following: loading a software application; accessing a model; and loading data from a data source.

7. The method of claim 6, wherein generating the virtual environment comprises generating a virtual room and providing views of the virtual room, wherein the views are synchronized with respect to each other and are displayable at respective client computers of the users to enable user interaction.

8. The method of claim 1, further comprising the analytics platform performing the analysis using historical data and real-time data.

9. The method of claim 1, wherein providing the analytics platform comprises providing an interactive visualization mechanism in the analytics platform to visualize historical and real-time data associated with the enterprise.

10. The method of claim 1, wherein providing the analytics platform comprises providing an expert model in the analytics platform to identify an expert to contact for a given issue.

11. The method of claim 1, wherein performing the analysis comprises performing one or more of the following: a metric computation engine computing at least one metric regarding a characteristic of the enterprise; a time-correlation engine to detecting time-dependent relationships among operational data; a prediction engine to predicting a future condition of an aspect of the enterprise; and a trending analysis engine to identify a trend in the enterprise.

12. The method of claim 1, further comprising using ontology and metadata information to relate data elements from different data sources, to relate issues with experts, and to relate events and processes.

13. A system comprising:
a processor;
a business intelligence platform executable on the processor, the business intelligence platform to:
receive data from one or more data sources;
provide business intelligence analysis of data in the one or more data sources; and
provide an interactive visualization based on the business intelligence analysis; and
a virtual collaboration platform executable on the processor to present a virtual environment to allow users to collaborate in the virtual environment, wherein the interactive visualization is presented in the virtual environment.

14. The system of claim 13, wherein the business intelligence platform and the virtual collaboration platform are cooperable to provide a collaborative business intelligence session in which resources of the business intelligence platform are made available to the users in the virtual environment.

15. The system of claim 13, further comprising an ontology and metadata layer to define relationships between data elements from different data sources, relationships between events and process steps, and relationships between issues and experts.

16. The system of claim 13, further comprising a model to map issues to experts and to allow identification of one or more experts to the users.

17. The system of claim 16, wherein the virtual collaboration platform enables the users to invite the one or more experts to participate in the virtual environment.

18. An article comprising at least one computer-readable storage medium containing instructions that upon execution by a computer system cause the computer system to:
integrate a business intelligence platform with a virtual collaboration platform;
present a virtual environment by the virtual collaboration platform, wherein the virtual environment allows collaboration by plural users to address a particular issue;
send requests to the business intelligence platform in response to activity of the plural users in the virtual environment, wherein the requests cause the business intelligence platform to apply business intelligence analytics.

19. The article of claim 18, wherein the business intelligence analytics include metric computation, prediction, and trending analysis.

20. The article of claim 18, wherein the instructions upon execution cause the computer system to further:
identify an expert associated with particular issue using a model; and
invite the expert to the virtual environment for collaboration among the plural users and the expert.
